(19) United States
(12) Patent Application Publication
(10) Pub. No.: US 2015/0183420 A1
(43) Pub. Date: Jul. 2, 2015

(54) DRIVE SYSTEM AND METHOD OF DRIVING A VEHICLE

(71) Applicant: SCANIA CV AB, Södertälje (SE)

(72) Inventors: Niklas Pettersson, Stockholm (SE); Mikael Bergquist, Hagersten (SE); Anders Kjell, Stockholm (SE); Mathias Björkman, Tullinge (SE); Johan Lindström, Nykoping (SE)

(21) Appl. No.: 14/410,630

(22) PCT Filed: Jun. 26, 2013
(86) PCT No.: PCT/SE2013/050783

§ 371 Date: Dec. 23, 2014

(30) Foreign Application Priority Data
Jun. 26, 2012 (SE) 1200394-3

(51) Int. Cl. B60W 20/00; B60W 10/26; B60W 10/08; B60W 10/184; B60W 30/18; B60W 10/06

(52) U.S. Cl. CPC B60W 20/106; B60W 30/18054; B60W 10/06; B60W 10/08; B60W 10/184; B60W 10/26; Y10S 903/93

(57) ABSTRACT

A drive system and a method of driving a vehicle (1). The drive system has a combustion engine (2), a brake device (24) with which the vehicle (1) can be braked, an electric machine (9), an energy storage (20) which is connected to the electric machine, at least one assembly (22) which is operated by electric energy, a planetary gear which comprises a sun wheel (10), a ring wheel (11) and a planet wheel holder (12). At an operation occasion when the vehicle (1) is stationary, no driving moment (T_{g}) is demanded by the vehicle (1) and the coupling member (15) is in the first position (I₁), a control unit activates the brake device (24) with a braking moment (T_{b}) such that the vehicle (1) is maintained in a stationary position at the same time as it controls the electric machine (9) such that it supplies a moment (Tₑₗ) which results in that the electric machine (9) generates so much electric effect (Eₑₗ) that operation of the assembly (22) is maintained.

### CROSS-REFERENCE TO RELATED APPLICATIONS

The present application is a 35 U.S.C. §§371 National Phase conversion of PCT/SE2013/050783, filed Jun. 26, 2013, which claims priority of Swedish Patent Application No. 1200394-3, filed Jun. 27, 2012, the contents of which are incorporated by reference herein. The PCT International Application was published in the English language.

### BACKGROUND OF THE INVENTION AND PRIOR ART

The present invention concerns a drive system and a method of driving a vehicle.

To use a conventional clutch mechanism which disconnects the input shaft of a gear box from the combustion engine during gear changing processes in the gear box involves disadvantages. When a stationary vehicle starts, the discs of the clutch mechanism slide against each other, thereby heating the discs. This heating results in increased fuel consumption and wear of the clutch discs. A conventional clutch mechanism is also relatively heavy and expensive. It also occupies a relatively large space in the vehicle. To use a hydraulic moment converter also results in losses.

Hybrid vehicles can be driven by a primary motor, which can be a combustion engine, and/or by a secondary motor, which can be an electric machine. The electric machine is equipped with at least one energy storage for storing electric energy and with control equipment for controlling the flow of electric energy between the energy storage and the electric machine. The electric machine can thereby alternately work as a motor or a generator dependent on the operation state of the vehicle. When the vehicle is braked, the electric machine generates electric energy which is stored in the energy storage. The stored electric energy may be used later, for example, for driving the vehicle and operating different auxiliary systems in the vehicle.

Swedish patent application SE 1051384-4, which has not been made public, shows a hybrid drive system with a planetary gear which comprises three components, namely a sun wheel, a planet wheel holder and a ring wheel. One of the three components of the planetary gear is connected to an output shaft of the combustion engine, a second component of the planetary gear is connected to an input shaft to the gear box and a third component of the planetary gear is connected to a rotor of an electric machine. The electric machine is connected to an energy storage such that it alternately can work as a motor or a generator. The rotation speed of electric machines can be controlled in a stepless manner. By controlling the rotation speed of the electric machine, the input shaft to the gear box can be given a desired rotation speed. With a hybrid system according to SE 1051384-4 no clutch mechanism needs to be used in the drive line of the vehicle.

In conventional hybrid vehicles with a clutch, the combustion engine cannot be used for charging the energy storage when the clutch is in an open position. When such a hybrid vehicle in the form of, for example, a bus is to drive away from a bus stop, there is a risk that it will be stationary a certain time during peak hours with engaged gear and the clutch in an open position. If the energy storage is at the same time used by other electrically operated assemblies in the vehicle , for example, a compressor of an AC-equipment, the energy storage may be discharged quite quickly. In this case, the engaged gear must be disengaged and the clutch must be closed in order to charge the energy storage.

### SUMMARY OF THE INVENTION

The object of the present invention is to provide a drive system for a vehicle of the initially mentioned kind, where the energy storage has the capacity to supply electric effect for the operation of at least one electrically operated assembly in the vehicle and also during operation occasions when the vehicle is stationary or driven at a low speed.

This object is achieved with a drive system of the invention. At occasions when the vehicle is stationary and the driver does not demand any driving moment of the vehicle, the combustion engine runs at the idle running rotation speed, the planetary gear is in an open position and a starting gear is engaged in the gear box. A control unit activates the electric machine, which creates a moment which brakes the output shaft of the combustion engine. A driving power is thereby created in the drive line which aims at making the vehicle start rolling. The brake device does however prevent the vehicle from starting to roll. The braking moment of the electric machine on the combustion engine causes electric energy to be led to the effect storage. In most cases, at least so much electric effect can be generated that said assembly can be operated. The amount of electric effect that is generated in the energy storage can if required be increased by controlling the electric machine such that it supplies a larger braking moment. In this case, the braking moment of the brake device can if required also be increased such that the vehicle does not start rolling. With the above mentioned measures, the energy storage should have a capacity to operate the electrically operated assembly at operation occasions when the vehicle is stationary.

According to an embodiment of the present invention, the control unit is adapted to receive information concerning the charge level of the energy storage and, at occasions when the charge level of the energy storage is lower than a limit level, to control the brake device and the electric machine such that it generates at least as much electric effect as said assembly consumes. If the energy storage has a high charge level, it is not always necessary that the electric machine must generate as much electric effect as said assembly consumes. In this case, the electric machine may at least during a period generate less electric effect than said assembly consumes. Alternatively, the charge level of the energy storage may be allowed to sink to the lowest acceptable level.

According to an embodiment of the present invention, at an operation occasion when the vehicle is stationary, the coupling member is in the first position and a driving moment is demanded by the vehicle and control the brake device such the control unit is adapted to supply a braking moment of a magnitude such that the vehicle starts rolling. The vehicle thereby starts rolling when a driving moment is demanded by the vehicle by a driver who presses down an accelerator pedal. When the energy storage has a higher charge level than said limit level, the control unit is with advantage adapted to release the brake device completely and control the electric machine such that it delivers a moment of a magnitude such that the vehicle is driven with the demanded moment. In this case, the electric machine is controlled such that it gives a moment in the form of a transmission ratio in relation to the demanded moment of the vehicle. The vehicle thereby starts rolling with the driving moment which is demanded by the driver.

According to an embodiment of the present invention, when the energy storage has a lower charge level than said limit level, the control unit is adapted to release the brake device completely, control the combustion engine such that it obtains a sufficiently high rotation speed for electric effect to be able to be generated in the energy storage and to control the electric machine such that it generates at least as much electric effect as is consumed by said assembly. In this case, the control unit may activate a motor control function which increases the rotation speed of the combustion engine concurrently with an increased speed of the vehicle. The rotor of the electric machine can thereby be made to rotate in a negative opposite direction in relation to the direction of rotation of the combustion engine also when the speed of the vehicle increases. Electric effect may thereby be generated during a desired time period. The rotation speed of the combustion engine is controlled such that the electric machine can generate as least as much effect in the energy storage as is consumed during operation of said assembly. The operation of said assembly can thereby be guaranteed also at occasions when the energy storage has a low charge level.

According to an alternative embodiment of the present invention, when the energy storage has a lower charge level than said limit level, the control unit is adapted to control the combustion engine such that it is driven with the idle running rotation speed, control the brake device to apply a braking moment which causes the vehicle to be driven with the demanded moment and to control the electric machine such that it generates at least as much electric effect in the energy storage as is consumed by said assembly. In this case, the brake device is used for supplying a braking moment such that the vehicle is driven with the demanded driving moment at the same time as electric effect is generated in at least the same amount as is consumed by said assembly. The operation of said assembly can thereby be guaranteed also at occasions when the energy storage has a low charge level.

According to an embodiment of the invention, the control unit is adapted to control the coupling member such that it is moved to the second position as soon as the vehicle obtains a speed at which it is possible to lock the output shaft of the combustion engine to the input shaft of the gear box. In particular, at occasions when the energy storage has a low charge level, it is suitable to lock the output shaft of the combustion engine to the input shaft of the gear box as quickly as possible. The combustion engine can thereby be responsible for driving the vehicle, the operation of said assembly and the charging of the energy storage.

According to an embodiment of the invention, the brake device is an existing brake in the vehicle. With advantage, the brake device is an existing brake which acts on the drive line or wheels of the vehicle. However, the brake device ought to have the capacity to supply a variable braking moment. Alternatively, the brake device may be a separate brake which is used only for supplying a variable braking moment with the purpose of generating electric energy in the energy storage.

According to an embodiment of the invention, the assembly is a compressor in an AC-equipment. Such equipment may during operation require the supply of a relatively high electric effect from the energy storage. The assembly may however be one or more arbitrary assemblies which are operated by electric energy from the energy storage.

According to another preferred embodiment of the invention, the output shaft of the combustion engine is connected to the sun wheel of the planetary gear, the input shaft of the gear box is connected to the planet wheel holder of the planetary gear and the rotor of the electric machine is connected to the ring wheel of the planetary gear. With such a design, the included components may be given a compact construction. The sun wheel and the planet wheel holder may be connected to the output shaft of the combustion engine and the input shaft of the gear box, respectively, with the help of spline joints or the like. It is thereby guaranteed that the sun wheel rotates with the same rotation speed as the output shaft of the combustion engine and that the planet wheel holder rotates with the same rotation speed as the input shaft of the gear box. The rotor of the electric machine may be fixedly arranged on an external peripheral surface of the ring wheel. The internal peripheral surface of the ring wheel is normally provided with cogs. The external peripheral surface of the ring wheel is normally smooth and very well suited for carrying the rotor of the electric machine. The ring wheel and the rotor of the electric machine thereby form a rotatable unit. Alternatively, the rotor of the electric machine may be connected to the ring wheel via a transmission. It is however possible to connect the output shaft of the combustion engine, the input shaft of the gear box and the rotor of the electric machine with any of the other components of the planetary gear.

### BRIEF DESCRIPTION OF THE DRAWINGS

In the following preferred embodiments of the invention are described, as examples, with reference to the annexed drawings, on which:

FIG. 1 shows a drive line of a vehicle with a drive system according to the present invention,

FIG. 2 shows the drive system in more detail,

FIG. 3 shows a flow chart which describes a first embodiment of a method according to the present invention and

FIG. 4 shows a flow chart which describes a second embodiment of a method according to the present invention.

### DETAILED DESCRIPTION OF PREFERRED EMBODIMENTS OF THE INVENTION

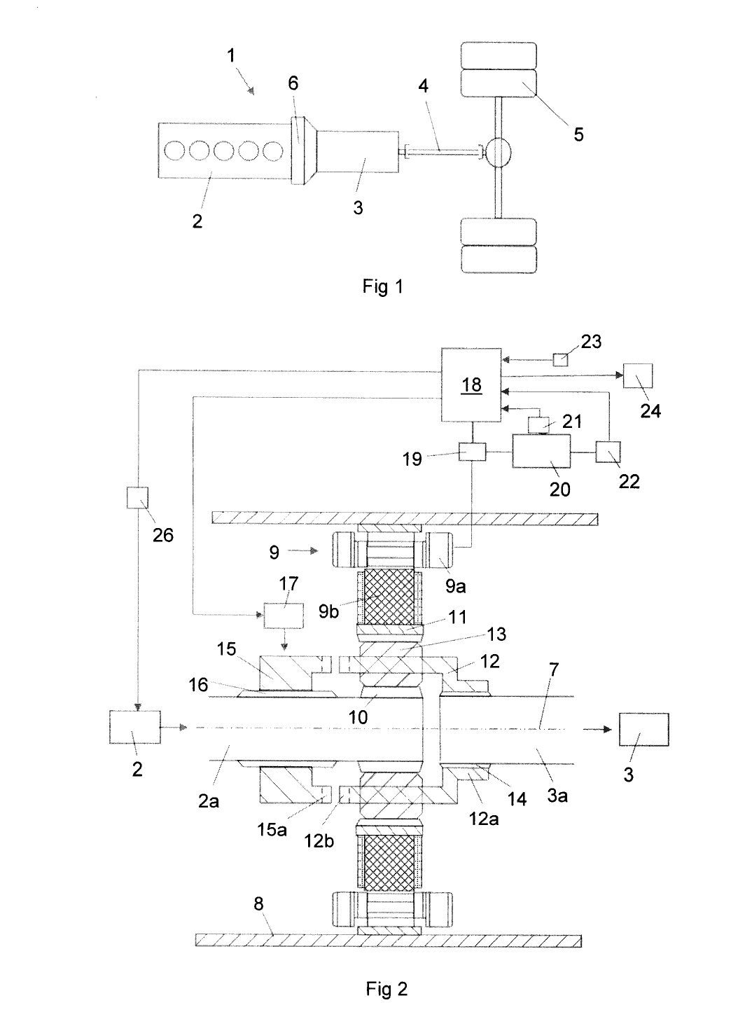

FIG. 1 shows a drive line for a heavy vehicle 1. The drive line comprises a combustion engine 2, a gear box 3, a number of drive shafts 4 and drive wheels 5. Between the combustion engine 2 and the gear box 3 the drive line comprises an intermediate part 6. FIG. 2 shows the components in the intermediate part 6 in more detail. The combustion engine 2 is provided with an output shaft 2a and the gear box 3 with an input shaft 3a in the intermediate part 6. The output shaft 2a of the combustion engine is coaxially arranged in relation to the input shaft 3a of the gear box. The output shaft 2a of the combustion engine and the input shaft 3a of the gear box are rotatably arranged around a common axis of rotation 7. The intermediate part 6 comprises a housing 8 which encloses an electric machine 9 and a planetary gear. The electric machine 9 comprises in a customary manner a stator 9a and a rotor 9b. The stator 9a comprises a stator core which is attached in a suitable manner on the inside of the housing 8. The stator core comprises the windings of the stator. The electric machine 9 is adapted to during certain operation states to store electric energy for supplying drive power to the input shaft 3a of the gear box and to during other operation states use the kinetic energy of the input shaft 3 of the gear box for extracting and storing electric energy.

The planetary gear is arranged substantially radially inside of the stator 9a and rotor 9b of the electric machine. The planetary gear comprises in a customary manner a sun wheel 10, a ring wheel 11 and a planet wheel holder 12. The planet wheel holder 12 carries a number of cog wheels 13 which are rotatably arranged in a radial space between the cogs of the sun wheel 10 and the ring wheel 11. The sun wheel 10 is attached on a peripheral surface of the output shaft 2a of the combustion engine. The sun wheel 10 and the output shaft 2a of the combustion engine rotate as a unit with a first rotation speed n₁. The planet wheel holder 12 comprises an attachment portion 12a which is attached on a peripheral surface of the input shaft 3a of the gear box with the help of a spline joint 14. With the help of this joint, the planet wheel holder 12 and the input shaft 3a of the gear box can rotate as a unit with a second rotation speed n₂. The ring wheel 11 comprises an external peripheral surface on which the rotor 9b is fixedly mounted. The rotor 9b and the ring wheel 11 constitute a rotatable unit which rotates with a third rotation speed n₃.

Since the intermediate part 6 between the combustion engine 2 and the gear box 3 in a vehicle is limited, it is required that the electric machine 9 and the planetary gear constitute a compact unit. The components 10-12 of the planetary gear are here arranged substantially radially inside of the stator 9a of the electric machine. The rotor 9b of the electric machine, the ring wheel 11 of the planetary gear, the output shaft 2a of the combustion engine and the input shaft 3a of the gear box are here rotatably arranged around a common axis of rotation 5. With such a design, the electric machine 9 and the planetary gear occupy a relatively small space.

The vehicle comprises a locking mechanism which is movable between a first open position in which the three components 10-12 of the planetary gear are allowed to rotate with different rotation speeds and a second locked position in which it locks together two of the components 10, 12 of the planetary gear such that the three components 10-12 of the planetary gear rotate with the same rotation speed. In this embodiment, the locking mechanism comprises a displaceable coupling member 15. The coupling member 15 is attached on the output shaft 2a of the combustion engine with the help of a spline joint 16. The coupling member 15 is in this case arranged, secured against turning, on the output shaft 2a of the combustion engine and displaceably arranged in an axial direction on the output shaft 2a of the combustion engine. The coupling member 15 comprises a coupling portion 15a which is connectable to a coupling portion 12b of the planet wheel holder 12. The locking mechanism comprises a schematically shown displacement member 17 adapted to displace the coupling member 15 between the first free position I₁ when the coupling portions 15a, 12b are not in engagement with each other and the second locked position I₂ when the coupling portions 15a, 12b are in engagement with each other. In the first open position, the output shaft 2 of the combustion engine and the input shaft 3 of the gear box can rotate with different rotation speeds. When the coupling portions 15a, 12b are in engagement with each other, the output shaft 2 of the combustion engine and the input shaft 3 of the gear box will rotate with the same rotation speed.

An electric control unit 18 is adapted to control the displacement member 17. The control unit 18 is also adapted to decide at which operation occasions the electric machine 9 is to work as a motor and at which operation occasions it is to work as a generator. In order to decide this, the control unit 18 can receive actual information from suitable operation parameters. The control unit 18 can be a computer with a suitable software for this purpose. One or more separate control units can be used. The control unit 18 also controls a schematically shown control equipment 19 which controls the flow of electric energy between an energy storage 20 and the stator 9a of the electric machine. At operation occasions when the electric machine 9 works as a motor, stored electric energy from the energy storage 20 is supplied to the stator 9a. At operation occasions when the electric machine works as generator, electric energy from the stator 9a is supplied to the energy storage 20. The energy storage 20 delivers and stores electric energy with a rated voltage in the order of 200-800 Volt.

A measurement instrument 21 is adapted to sense a parameter which is related to the charge level in the energy storage 20. The energy storage 20 is also connected to one or more electrically operated assemblies 22 in the vehicle. The electrically operated assemblies may be a compressor in an AC-equipment. During operation of the vehicle 1, a driver demands a driving moment T_{g} of the vehicle 1 with a schematically shown accelerator pedal 23. The vehicle 1 is equipped with at least one brake device 24 with which the drive wheels 5 of the vehicle can be braked. The vehicle 1 is equipped with a motor control function 26 with which the moment T₁ and rotation speed n₁ of the combustion engine can be controlled. The control unit 18 has, for example, the possibility to activate the motor control function 26 in order to create a momentless state in the gear box 3 when gears are engaged and disengaged in the gear box 3.

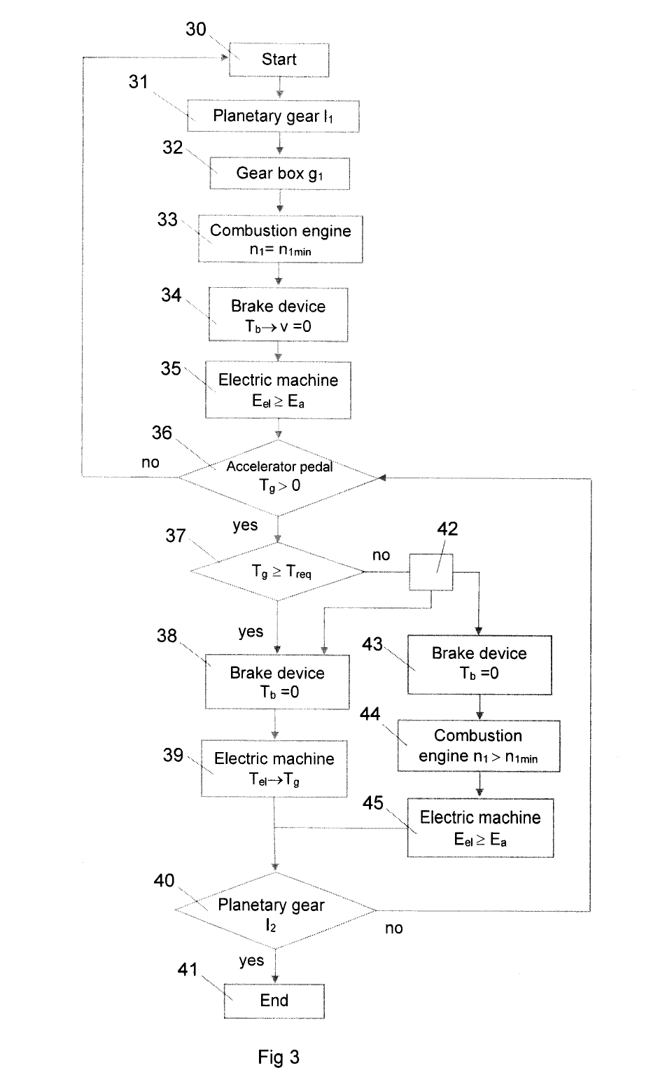

FIG. 3 shows a flow chart which describes a method which extends from the start of the vehicle from a stationary position with the planetary gear in the first position I₁ until the vehicle has obtained a speed with which it is possible to arrange the planetary gear in the second locked position I₂. The method describes a starting process of the vehicle 1. The method starts at the step 30. If the planetary gear is not already in the first open position I₁, it is arranged in the first position I₁, at the step 31. The output shaft 2a of the combustion engine and the input shaft 3a of the gear box are thereby freely moveable in relation to each other. A starting gear g₁ is engaged in the gear box 3 which appears from the step 32. The brake device 24 is applied, at the step 33, with a braking moment T_{b} of a magnitude such that the vehicle 1 is stationary v=0. It appears from the step 34 that the combustion engine 2 is in operation and that it is driven with an idle running rotation speed n₁ₘᵢₙ. At the step 35, the control unit 18 has activated the electric machine 9.

The output shaft 2a of the combustion engine and the sun wheel 10 here rotate with the idle running rotation speed n₁ₘᵢₙ of the combustion engine while the input shaft 3a of the gear box and the planet wheel holder 12 are held immovable by the brake device 24 via the drive line of the vehicle. In this state, the ring wheel 11 and the rotor 9b of the electric machine obtain a rotation movement in a negative direction, i.e. in an opposite direction in relation to the rotation direction of the combustion engine 2. The control unit 18 controls the activation of the electric machine 9 with the help of the control mechanism 19 such that it in this case counteracts the rotation movement of the ring wheel 11 with a moment Tₑₗ. The contrary directed moment Tₑₗ of the electric machine 9 causes current to be led from the electric machine 9 to the energy storage 20 and the other consumers in the vehicle 1. The control unit 18 receives information concerning the charge level q of the energy storage 20 from the measurement instrument 21 and information concerning the consumption of electric effect Eₐ of the electric assembly 22. The control unit 18 controls the electric machine 9 such that it supplies a braking moment Tₑₗ (acts with a braking moment on the combustion engine) of a magnitude such that the electric machine 9 at least supplies as much electric effect Eₘ to the energy storage 20 and the other consumers in the vehicle 1 as the electric assembly 22 consumes Eₐ. It is thereby guaranteed that the charge level q of the energy storage 20 does not sink when the vehicle is stationary at the same time as the electric assembly 22 receives necessary electric effect Eₐ in order to maintain its operation.

At the step 36, the control unit 18 senses if the driver demands a driving moment T_{g} of the vehicle with the help of the accelerator pedal 23. If the vehicle 1 is to be stationary for a further while, the driver does not press down the accelerator pedal 23 to produce the accelerator pedal demanded driving moment T_{g}=0. In this case the method starts again at the step 30. When the driver decides that the vehicle 1 is to start rolling, the driver presses down the accelerator pedal 23 and demands a driving moment T_{g} of the vehicle. At the step 37, the control unit 18 compares if the demanded driving moment T_{g} is larger than or equal to a necessary moment T_{req} which is necessary for the operation of the assembly 22. If the driving moment T_{g} is larger than the necessary moment T_{req}, there is an excess of effect for operating the assembly 22. At a normal start of the vehicle 1, the combustion engine 2 is driven in an idle running mode. At an initial stage after the start, which may be in the order of 1 second (at a normal acceleration), the ring wheel 11 and the rotor 9b of the electric machine rotate in a negative direction such that electric energy is generated and stored in the energy storage 20. When the vehicle 1 reaches a speed v₁ after about 1 second (depending on the acceleration), the ring wheel 11 and the rotor 9b of the electric machine start to rotate in a positive direction. A supply of electric effect Eₑₗ to the electric machine 9 is thereby required in order to increase the speed of the vehicle 1 further. When the vehicle reaches a speed v₂, it is possible to arrange the planetary gear in a locked position I₂. At a normal starting process of the vehicle 1, normally more electric effect is consumed than can be generated. The consumption of electric effect becomes in particular substantial if the energy storage 20 at the same time is to supply the electrically operated assembly 22 with electric effect Eₐ. If the vehicle 1 during a longer period is driven with a speed which is higher than v₁ and lower speed than v₂, the consumption of electric effect may get so large that the energy storage 20 discharges completely.

If the control unit 18, at 37, receives information from the measurement instrument 21 that indicates that there is an excess of effect, the energy storage 20 does not risk being discharged if the vehicle 1 performs a normal start. The brake device 24 is released completely such that T_{b}=0, at the step 38, and the vehicle 1 starts rolling. At the step 39, the electric machine 25 supplies a moment Tₑₗ such that the vehicle 1 obtains the driving moment T_{g} demanded by the accelerator pedal 23. The excess or the deficit of electric effect to the electric assembly 24 is taken care of by the energy storage 20. The control unit 18 investigates, at the step 40, if it is possible to lock the planetary gear. If this is possible, the planetary gear is arranged in the second locked position I₂ and the starting process ends at 41. In the locked position of the planetary gear, the combustion engine 2 can be responsible for the whole operation of the vehicle 1, the operation of the electric assembly 22 and, if required, for charging the energy storage 20.

If the control unit 18, at 40, finds that the planetary gear cannot be arranged in the second locked position I₂, the method starts again at the step 36. If the accelerator pedal 23 still is pressed down and a driving moment T_{g} is demanded by the vehicle 1, the method continues at the step 37. At the step 37, the control unit 18 compares if the demanded driving moment T_{g} is larger than the necessary moment T_{req}. If T_{g} is less than the necessary moment T_{req}, there is a deficit of effect for the operation of the assembly. At 42, it is determined if the energy storage 20 has the capacity to handle this deficit. If this is the case, the method continues at 39. If this is not the case, the method continues in this case, at the step 43, where it appears that the brake device 24 does not supply any braking moment T_{b}=0. The vehicle 1 is thus not braked at all by the brake device 24. However, in this case, at the step 44, the rotation speed n₁ of the combustion engine is increased to a higher level than the idle running rotation speed n₁ₘᵢₙ.

Since the rotation speed n₁ of the combustion engine is increased, the ring wheel 11 can be made to rotate in a negative direction and electric effect is generated in the energy storage 20 during a longer time than if the combustion engine is driven with the idle running rotation speed n₁ₘᵢₙ. The control unit 18 controls the rotation speed n₁ of the combustion engine, via the motor control function 26, such that electric effect is generated at a desired amount and led to the energy storage 20. The control unit 18 controls, at the step 45, the rotation speed n₁ of the combustion engine such that at least as much electric effect Eₐ as is consumed by the electric assembly Eₐ. The electric machine 9 supplies a moment Tₑₗ which is a transmission ratio times the demanded moment T_{g}. The control unit 18 investigates, at the step 40, if it is possible to lock the planetary gear. If this is possible, the planetary gear is arranged in the second locked position I₂ and the starting process ends at the step 41. Otherwise, the method starts again at the step 36.

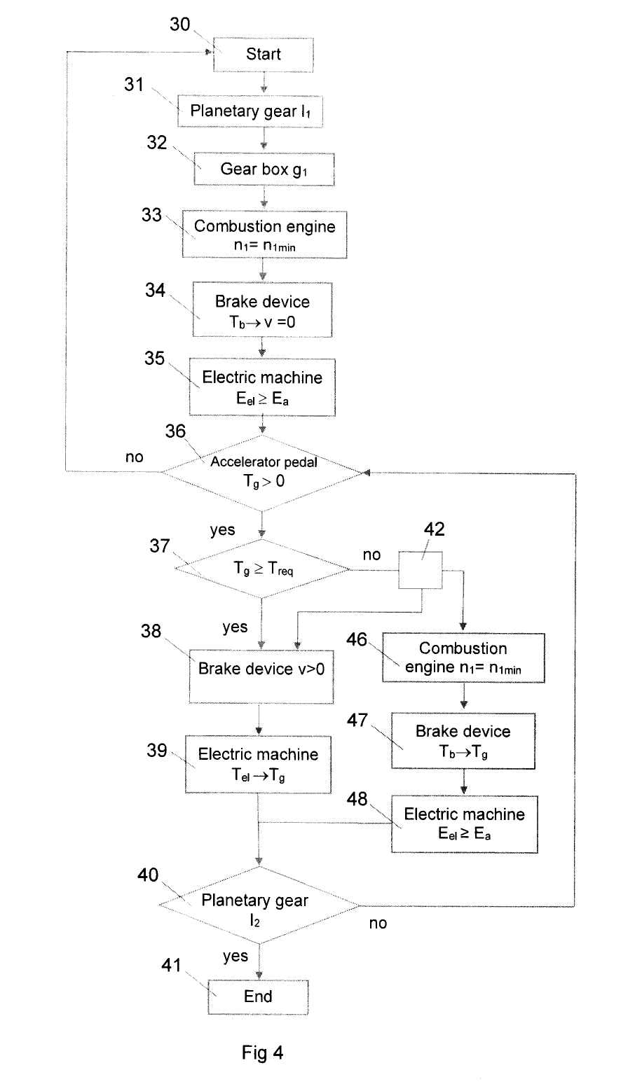

FIG. 4 shows an alternative method for a starting process of the vehicle 1 when it is equipped with an electric assembly 22 which requires electric effect Eₐ for its operation. The method in FIG. 4 corresponds to the method in FIG. 3 except in the case that the energy storage 20, and at the step 37, provides an excess or deficit of effect determined by comparing if the demanded driving moment T_{g} is larger than or equal with a necessary moment T_{req}. If there is an excess of effect which enables the operation of the assembly 22, the method continues at the step 38. When this is not the case, it is determined, at the step 42, if the energy storage 20 has such a charge level that the assembly can be operated anyway. If this is the case, the method continues at the step 38. If this is not the case, the method continues at the step 46. In this case the combustion engine 2 is driven with the idle running rotation speed n₁ₘᵢₙ. At the step 47, the brake device 24 is applied such that it brakes the vehicle 1. The control unit 18 controls the brake device 24 such that it supplies a braking moment T_{b} which causes the vehicle 1 to obtain the moment T_{g} which is demanded by the accelerator pedal. The control unit 18 controls the electric machine 9, at the step 48, such that it produces at least as much electric effect Eₘ as corresponds to the energy need Eₐ of the electric assembly. The control unit 18 investigates, at the step 40, if it is possible to lock the planetary gear. If this is possible, the planetary gear is arranged in the second locked position I₂ and the starting process ends at the step 41. Otherwise the method starts again at the step 36.

In the flow chart in FIG. 3, the steps 43-45 are used when there is a deficit of effect for the operation of the electric assembly 22. In the flow chart in FIG. 4, the steps 46-48 are used when there is a deficit of effect for the operation of the electric assembly 22. It is obviously possible to use the two different measures alternately or in combination when there is a need to supply extra effect in order to operate the electric assembly 22.

The invention is in no way limited to the embodiment described on the drawings but can be varied freely within the scope of the claims. For example, a transmission with a gear ratio can be arranged between the rotor 9 and the ring wheel 11. The rotor 9 and the ring wheel 11 need thus not rotate with the same rotation speed.

1. A drive system for a vehicle, the drive system comprising a combustion engine with an output shaft, a gear box with an input shaft, a brake device with which the vehicle can be braked, an electric machine which comprises a stator and a rotor, an energy storage which is connected to the electric machine, at least one assembly which is operated by electric energy from the energy storage, a planetary gear which comprises a sun wheel, a ring wheel and a planet wheel holder and a coupling member wherein the coupling member is movably arranged between a first position in which the coupling member allows rotation of the components in the planetary gear with different respective rotation speeds and a second position in which the coupling member locks the components in relation to each other such that they rotate with the same rotation speed;
the output shaft of the combustion engine is connected to a first one of the components of the planetary gear such that rotation of the output shaft leads to rotation of the first component;
the input shaft of the gear box is connected to a second one of the components of the planetary gear such that rotation of the input shaft leads to rotation of the second component;
the rotor of the electric machine is connected to a third one of the components of the planetary gear such that rotation of the rotor leads to rotation of the third component;
at an operation occasion when the vehicle is stationary, no driving moment is demanded by the vehicle and the coupling member is in the first position, a control unit which is configured to activate the brake device to brake the vehicle with a braking moment such that the vehicle is maintained in a stationary position at the same time as the control unit controls the electric machine such that the electric machine supplies a moment which causes the electric machine to generate so much electric effect that the operation of the assembly is maintained.

2. A drive system according to claim 1, further comprising the control unit is configured to receive information concerning the charge level of the energy storage and at occasions when the charge level of the energy storage is lower than a limit level, the unit is configured to control the brake device and the electric machine such that the electric machine generates at least as much electric effect as the assembly consumes.

3. A drive system according to claim 1, further comprising at an operation occasion when the vehicle is stationary, the coupling member is in the first position and a driving moment is demanded by the vehicle, the control unit is configured to control the brake device to cause the brake device to supply a braking moment of a magnitude such that the vehicle starts rolling.

4. A drive system according to claim 3, further comprising when the energy storage has a higher charge level than the limit level, the control unit disengages the brake device completely and controls the electric machine to deliver a moment such that the vehicle is driven with the demanded moment.

5. A drive system according to claim 3, further comprising when the energy storage has a lower charge level than the limit level, the control unit releases the brake device completely, controls the combustion engine such that it obtains a sufficiently high rotation speed for electric effect to be generated and controls the electric machine such that the electric machine generates at least as much electric effect as is consumed by the assembly.

6. A drive system according to claim 3, further comprising, when the energy storage has a lower charge level than the limit level, the control unit controls the combustion engine such that the engine is driven with an idle running rotation speed, controls the brake device such that it applies a braking moment which causes the vehicle to be driven with the demanded moment and controls the electric machine such that it generates at least as much electric effect as is consumed by the assembly.

7. A drive system according to claim 4, further comprising the control unit is configured to control the coupling member to be moved to the second position as soon as the vehicle obtains a speed at which it is possible to lock the output shaft of the combustion engine to the input shaft of the gear box.

8. A drive system according to claim 1, wherein the brakew device is an existing wheel brake in the vehicle.

9. A drive system according to claim 1, wherein the assembly is a compressor in an AC-equipment.

10. A drive system according to claim 1, further comprising the output shaft of the combustion engine is connected to the sun wheel of the planetary gear, the input shaft of the gear box is connected to the planet wheel holder of the planetary gear and the rotor of the electric machine is connected to the ring wheel of the planetary gear.

11. A method of driving a vehicle, wherein the vehicle comprises a combustion engine with an output shaft, a gear box with an input shaft , a brake device with which the vehicle can be braked, an electric machine which comprises a stator and a rotor, an energy storage connected to the electric machine, at least one assembly which is operated by electric energy from the energy storage , a planetary gear which comprises a sun wheel, a ring wheel, a planet wheel holder and a coupling member which is movably arranged between a first position, in which the coupling member allows rotation of the components in the planetary gear with different rotation speeds, and a second position, in which the coupling member locks the components in relation to each other such that they rotate with the same rotation speed, and wherein the output shaft of the combustion engine is connected to a first one of the components of the planetary gear such that rotation of the output shaft leads to rotation of the first component, wherein the input shaft of the gear box is connected to a second one of the components of the planetary gear such that rotation of the input shaft leads to rotation of the second component and the rotor of the electric machine is connected to a third one of the components of the planetary gear such that rotation of the rotor leads to rotation of the third component;
the method comprising:
at an operation occasion when the vehicle is stationary, no driving moment is demanded by the vehicle and the coupling member is in the first position, activating the brake device such that it brakes the vehicle with a braking moment such that the vehicle is maintained in a stationary position and at the same time controlling the electric machine to supply a moment which causes the electric machine to generate so much electric effect that the operation of the assembly is maintained.

12. A method according to claim 11, further comprising receiving information concerning the charge level of the energy storage and when the charge level of the energy storage is lower than a limit level, controlling the brake device and the electric machine such that the electric machine generates at least as much electric effect as the assembly consumes.

13. A method according to claim 11, further comprising at an operation occasion when the vehicle is stationary, the coupling member is in the first position and a driving moment is demanded by the vehicle, the step of controlling the brake device such that it supplies a braking moment of a magnitude such that the vehicle starts rolling.

14. A method according to claim 13, further comprising when the energy storage has a higher charge level than the limit level, the steps of disengaging the brake device completely and controlling the electric machine such that it delivers a moment such that the vehicle is driven with the demanded moment.

15. A method according to claim 13, further comprising when the energy storage has a lower charge level than the limit level, the steps of releasing the brake device completely and controlling the combustion engine to obtain a sufficiently high rotation speed for electric energy to be able to be generated and controlling the electric machine such that it generates at least as much electric effect as is consumed by the assembly.

16. A method according to claim 13, further comprising when the energy storage has a lower charge level than the limit level, the steps of controlling the combustion engine such that it is driven with the idle running rotation speed, controlling the brake device such that it applies a braking moment which causes the vehicle to be driven with the demanded moment and controlling the electric machine to generate at least as much electric effect as is consumed by the assembly.

17. A method according to claim 14, further comprising controlling the coupling member to be moved to the second position as soon as the vehicle obtains a speed at which it is possible to lock the output shaft of the combustion engine to the input shaft of the gear box.

18. A method according to claim 11, further comprising using an existing brake in the vehicle as the brake device.

19. A method according to claim 11, further comprising operating an assembly in the form of a compressor in an AC-equipment with the help of the energy storage.

20. A method according to claim 11, further comprising connecting the output shaft of the combustion engine to the sun wheel of the planetary gear, connecting the input shaft of the gear box to the planet wheel holder of the planetary gear and connecting the rotor of the electric machine to the ring wheel of the planetary gear.

21. (canceled)

22. A computer program product comprising a non-volatile data storage medium which is readable by a computer, wherein a computer program code of a computer program is stored in the storage medium and the program code causes a computer to implement a method according to claim 11, when the computer program code is executed in the computer.

23. A vehicle comprising a drive system according to claim 1.
